(19) United States
(12) Patent Application Publication
(10) Pub. No.: US 2020/0130710 A1
(43) Pub. Date: Apr. 30, 2020

(54) CONTROL DEVICE OF AUTONOMOUS VEHICLE

(71) Applicant: DENSO CORPORATION, Kariya-city (JP)

(72) Inventors: Tomomi HASE, Kariya-city (JP); Noriaki IKEMOTO, Kariya-city (JP); Mitsuharu HIGASHITANI, Kariya-city (JP)

(73) Assignee: DENSO CORPORATION, Kariya-city (JP)

(21) Appl. No.: 16/729,638

(22) Filed: Dec. 30, 2019

Related U.S. Application Data
(63) Continuation of application No. PCT/JP2018/019022, filed on May 17, 2018.

(30) Foreign Application Priority Data
Jul. 4, 2017 (JP) 2017-131223

(51) Int. Cl. B60W 60/00; B60W 30/18

(52) U.S. Cl. CPC B60W 60/0015; B60W 30/18163; G05D 1/0276; B60W 2720/106; B60W 2556/65; B60W 2554/802

(57) ABSTRACT

A control device includes a device status sensor which senses the status of a safety device installed to an autonomous vehicle, and a vehicle controller which controls the autonomous vehicle. The vehicle controller is capable of implementing each of a normal travel mode and a safe travel mode in which the level of safety is higher than in the normal travel mode. In response to the device status sensor sensing that the safety device has been unlocked, the vehicle controller performs the process of switching from the normal travel mode to the safe travel mode.

### CROSS REFERENCE TO RELATED APPLICATIONS

This application is based on and claims the benefit of priority from Japanese Patent Application No. 2017-131223 filed Jul. 4, 2017, the entire disclosure of which is incorporated herein by reference.

### BACKGROUND

### Technical Field

The present disclosure relates to a control device of an autonomous vehicle.

### Related Art

Autonomous vehicles have been developed. The driving operations of some autonomous vehicles are fully automated while the driving operations of other autonomous vehicles are only partially automated.

As with conventional vehicles, autonomous vehicles are also equipped with safety devices for ensuring the safety of occupants. Examples of the safety devices include seat belts and door locking systems. In the case of autonomous vehicles that drive and operate themselves fully automatically, the occurrence of the vehicles starting to travel by the start of autonomous driving while the safety devices have been unlocked is undesirable.

### BRIEF DESCRIPTION OF THE DRAWINGS

In the accompanying drawings:

FIG. 1 is a diagram schematically showing a control device according to the first embodiment and an overall configuration of an autonomous vehicle including the control device;

FIG. 2 is a flowchart showing the flow of processes performed by the control device in FIG. 1;

FIG. 3 is a flowchart showing the flow of processes performed by the control device in FIG. 1;

FIG. 4 is a flowchart showing the flow of processes performed by the control device in FIG. 1;

FIG. 5 is a diagram showing an example of a restricted area set around the autonomous vehicle;

FIG. 6 is a diagram showing an example of the restricted area set around the autonomous vehicle;

FIG. 7 is a flowchart showing the flow of processes performed by the control device in FIG. 1;

FIG. 8 is a diagram showing an example of the restricted area set around the autonomous vehicle;

FIG. 9 is a flowchart showing the flow of processes performed by the control device in FIG. 1;

FIG. 10 is a flowchart showing the flow of processes performed by the control device in FIG. 1;

FIG. 11 is a flowchart showing the flow of processes performed by the control device in FIG. 1;

FIG. 12 is a flowchart showing the flow of processes performed by the control device in FIG. 1;

FIG. 13 is a flowchart showing the flow of processes performed by the control device in FIG. 1;

FIG. 14 is a diagram for describing how the position of the autonomous vehicle in a column is changed;

FIG. 15 is a flowchart showing the flow of processes performed by the control device in FIG. 1;

FIG. 16 is a flowchart showing the flow of processes performed by the control device in FIG. 1;

FIG. 17 is a flowchart showing the flow of processes performed by the control device in FIG. 1;

FIG. 18 is a diagram showing an example of the restricted area set around the autonomous vehicle;

FIG. 19 is a diagram showing an example of the restricted area set around the autonomous vehicle;

FIG. 20 is a diagram showing an example of the restricted area set around the autonomous vehicle;

FIG. 21 is a diagram showing an example of the restricted area set around the autonomous vehicle;

FIG. 22 is a flowchart showing the flow of processes performed by the control device in FIG. 1;

FIG. 23 is a flowchart showing the flow of processes performed by the control device in FIG. 1;

FIG. 24 is a flowchart showing the flow of processes performed by a control device according to the second embodiment;

FIG. 25 is a flowchart showing the flow of processes performed by a control device according to the third embodiment; and

FIG. 26 is a flowchart showing the flow of processes performed by a control device according to the fourth embodiment.

### DESCRIPTION OF SPECIFIC EMBODIMENTS

In the control device disclosed in JP-A-2016-199104, when the operation to unlock a door lock, the operation to unfasten a seat belt, or the like is detected while an autonomous vehicle is not in motion, the shift position is set to the non-drivable range. With such control, the occurrence of autonomous vehicles starting to automatically travel in the state where safety devices have been unlocked is prevented.

An occupant may unlock the safety device not only while the autonomous vehicle is not in motion, but also while the autonomous vehicle is driving itself. Particularly, although manual driving allows a driver to always know the status of the occupants, autonomous driving may allow continuation of travel with the safety device unlocked because nobody knows the status of the occupants. However, JP-A-2016-199104 mentioned above presents no specific studies on how to address the situation where the safety device is unlocked during travel.

In view of the foregoing, it is desired to have a control device that ensures the safety of occupants even when a safety device has been unlocked during travel of an autonomous vehicle.

Hereinafter, the present embodiment will be described with reference to the accompanying drawings. In order to facilitate understanding of the description, the same structural elements in the drawings share the same reference signs wherever possible, and overlapping description is omitted.

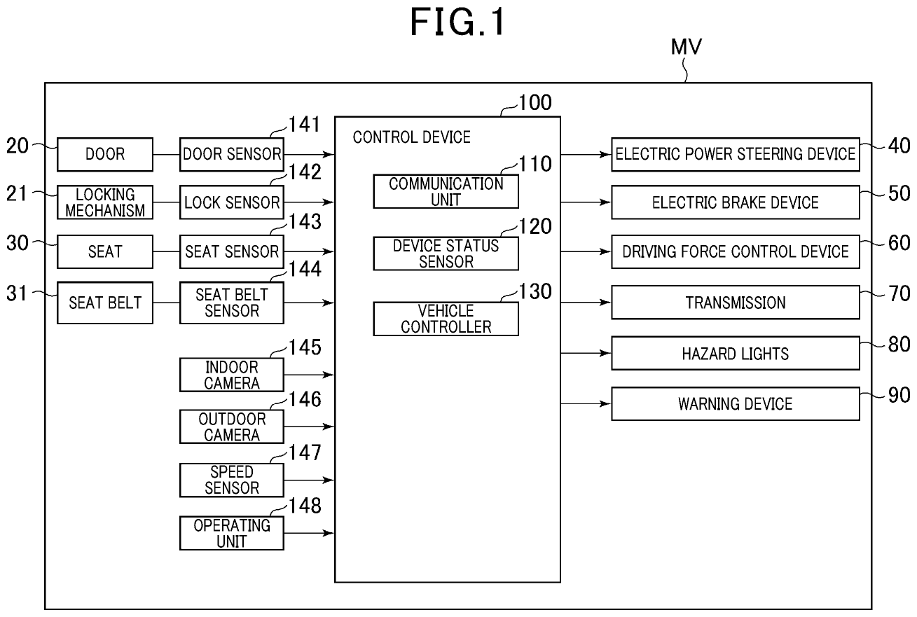

A control device 100 according to the first embodiment is mounted on an autonomous vehicle MV and is configured as a device for controlling the autonomous vehicle MV. Prior to the description of the control device 100, the configuration of the autonomous vehicle MV is described with reference to FIG. 1.

The autonomous vehicle MV is configured as a vehicle in which all driving operations required for travel (driving, steering, and breaking operations) can be automatically performed. Furthermore, the autonomous vehicle MV is capable of traveling through manual driving by a driver. By operating an operating unit 148 installed to the interior of the autonomous vehicle MV, an occupant can cause the autonomous vehicle MV to start driving itself.

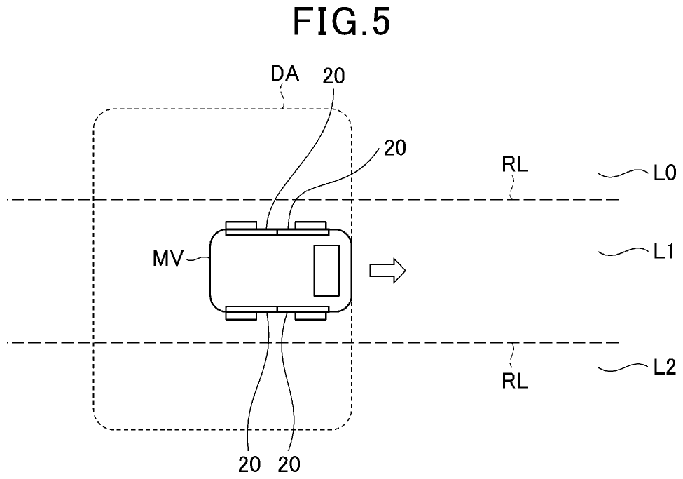

The autonomous vehicle MV has a plurality of doors 20 that allow occupants to enter and exit the interior (refer to FIG. 5). Note that in FIG. 1, the plurality of doors 20 are shown as a single unit.

Each of the doors 20 includes a locking mechanism 21 for locking the door 20. The locking mechanism 21 is used for switching between an unlocked state where the door 20 can be opened and a locked state where the door 20 cannot be opened. An occupant can switch between the unlocked state and the locked state by manually operating the locking mechanism 21. The locking mechanism 21 serves as one “safety device” installed to the autonomous vehicle MV.

A plurality of seats 30 for occupants to sit on are installed to the interior of the autonomous vehicle MV. Note that in FIG. 1, the plurality of seats 30 are shown as a single unit. Although illustration has been omitted, one of the plurality of seats 30, specifically, the seat 30 installed in a position on the front right side in the interior, is the driver seat of the autonomous vehicle MV.

A seat belt 31 is provided on each of the seats 30. The seat belt 31 is used for restraining, to the seat 30, the body of an occupant seated in the seat 30. The occupant can manually fasten the seat belt 31 and can manually unfasten the seat belt 31. The seat belt 31 serves as one “safety device” installed to the autonomous vehicle MV together with the aforementioned locking mechanism 21.

The autonomous vehicle MV includes, in addition to the foregoing, an electric power steering device 40, an electric brake device 50, a driving force control device 60, a transmission 70, hazard lights 80, and a warning device 90.

The electric power steering device 40 applies an electric steering force to a steering shaft. In the autonomous vehicle MV, during autonomous driving, the electric power steering device 40 generates the whole steering force required for travel along a traffic lane without the need for the driver to perform a steering operation. In the autonomous vehicle MV, during the absence of autonomous driving, the electric power steering device 40 applies an auxiliary steering force to the steering shaft so that the force to be applied by the driver to a steering wheel is reduced.

Operations of the electric power steering device 40 are controlled by the control device 100. Note that in another embodiment, an electronic control unit (ECU) that controls the electric power steering device 40 may be separately provided. In this case, the control device 100 controls the operations of the electric power steering device 40 by communicating with the ECU.

The electric brake device 50 generates an electric braking force, thereby decelerating or stopping the autonomous vehicle MV. The electric brake device 50 according to the present embodiment is configured as what is called an eddy current brake device (ECB).

In the autonomous vehicle MV, during autonomous driving, the electric brake device 50 automatically generates a braking force without the need for the driver to perform a braking operation. Operations of the electric brake device 50 are controlled by the control device 100. Note that in another embodiment, an ECU that controls the electric brake device 50 may be separately provided. In this case, the control device 100 controls the operations of the electric brake device 50 by communicating with the ECU.

The driving force control device 60 is used for adjusting a driving force of a driving device (such as an engine and a motor generator) included in the autonomous vehicle MV. The driving force control device 60 is configured as an ECU provided separately from the control device 100. The control device 100 adjusts the driving force of the driving force control device 60 by communicating with the driving force control device 60. This enables adjustment of the travel speed of the autonomous vehicle MV. Note that in another embodiment, the control device 100 may include such functions of the driving force control device 60.

The transmission 70 is a speed changing device. The control device 100 is capable of adjusting, for example, the travel speed of the autonomous vehicle MV by adjusting the gear ratio of the transmission 70 as appropriate. Furthermore, the control device 100 is capable of setting the gear position to “neutral” so that the driving force of the driving device is not transmitted to the wheels. Note that in another embodiment, an ECU that controls the transmission 70 may be separately provided. In this case, the control device 100 controls the operations of the transmission 70 by communicating with the ECU.

The hazard lights 80 are light-emitting devices provided on both sides of the autonomous vehicle MV. The control device 100 is capable of causing the hazard lights 80 to flash to warn other vehicles traveling nearby.

The warning device 90 is used for emitting, for example, sound for warning occupants in the interior. For example, when the seat belt 31 is unlocked or released during travel, the control device 100 causes the warning device 90 to operate to warn the occupants.

The configuration of the control device 100 is described below with reference to FIG. 1. The control device 100 is configured as a computer system including a central processing unit (CPU), a read-only memory (ROM), a random-access memory (RAM), and the like. The control device 100 includes a communication unit 110, a device status sensor 120, and a vehicle controller 130 as functional control blocks. Furthermore, the control device 100 includes a door sensor 141, a lock sensor 142, a seat sensor 143, a seat belt sensor 144, an indoor camera 145, an outdoor camera 146, a speed sensor 147, and an operating unit 148, as peripheral devices connected to a main body part of the computer system.

Note that the control device 100 having the above configuration may be configured as a single computer system, and in another embodiment, a plurality of computer systems may operate in coordination and, as a whole, function as the control device 100. In yet another embodiment, a part or the whole of the control device 100 may be installed in a position different from the autonomous vehicle MV and control autonomous driving of the autonomous vehicle MV by communicating with the autonomous vehicle MV.

The communication unit 110 is a part that functions as a communication interface for the autonomous vehicle MV to perform inter-vehicle communication (V to V) with another vehicle. By performing bi-directional communication with another vehicle via the communication unit 110, the control device 100 can change a path in which the other vehicle is traveling or change a path in which the autonomous vehicle MV is traveling, for example.

Note that another vehicle traveling close to the autonomous vehicle MV will be hereinafter referred to also as a “nearby vehicle”. Furthermore, in the case where the nearby vehicle is an autonomous vehicle, the nearby vehicle is also referred to as a “nearby autonomous vehicle” in particular.

The device status sensor 120 is a part that senses the status of the safety device installed to the autonomous vehicle MV. The device status sensor 120 is capable of sensing whether each safety device (in the present embodiment, the locking mechanism 21 and the seat belt 31) is functioning or has been unlocked.

The vehicle controller 130 is a part that controls the autonomous vehicle MV. By controlling each of the electric power steering device 40, the electric brake device 50, the driving force control device 60, the transmission 70, and the like, the vehicle controller 130 performs processes required to achieve autonomous driving of the autonomous vehicle MV.

When no safety devices have been unlocked, the vehicle controller 130 implements the “normal travel mode” which is a travel mode to be applied at normal times. Other than this, the “safe travel mode” can be implemented by the vehicle controller 130. The safe travel mode provides a higher level of safety than the normal travel mode does. The vehicle controller 130 ensures the safety of occupants by switching from the normal travel mode to the safe travel mode as necessary. Specific implementation of the safe travel mode will be described later.

The door sensor 141 is used for sensing whether each door 20 is open. The door sensor 141 can be configured as a mechanical switch including a contact that switches between open and closed states along with opening and closing of the door 20, for example. Instead of this implementation, the status of each door 20 may be sensed by analyzing an image captured by the indoor camera 145 to be described later. The status of each door 20 sensed by the door sensor 141 is transmitted to the control device 100.

The lock sensor 142 is used for sensing the status of each locking mechanism 21. The lock sensor 142 senses whether the door 20 is locked or unlocked by the locking mechanism 21. The status of each locking mechanism 21 sensed by the lock sensor 142 is transmitted to the control device 100. The device status sensor 120 described earlier senses the status of the locking mechanism 21 based on signals transmitted from the lock sensor 142.

The seat sensor 143 is used for sensing the status of each seat 30. The “status of each seat 30” herein means a recline angle of the seat 30. The status of each seat 30 sensed by the seat sensor 143 is transmitted to the control device 100.

The seat belt sensor 144 is used for sensing the fastening status of each seat belt 31. The seat belt sensor 144 senses whether each seat belt 31 is fastened or unfastened. The fastening status of each seat belt 31 sensed by the seat belt sensor 144 is transmitted to the control device 100. The device status sensor 120 described earlier senses the status of the seat belt 31 based on signals transmitted from the seat belt sensor 144.

Note that even in the state where the seat belt 31 is fastened, if the recline angle of the seat 30 corresponding to the seat belt 31 is too great (i.e., if the seat 30 is reclined too far), the seat belt 31 cannot exhibit the functions thereof. Therefore, also when the seat sensor 143 senses that the recline angle of the seat 30 is too great, the device status sensor determines the seat belt 31 in the seat 30 as having been unlocked.

The indoor camera 145 is used for capturing an image of the interior of the autonomous vehicle MV. The indoor camera 145 includes a complementary metal-oxide-semiconductor (CMOS) sensor, for example. The image of the interior captured by the indoor camera 145 includes at least images of all the seats 30. The image is transmitted to the control device 100. By analyzing the image transmitted from the indoor camera 145, the control device 100 can sense the presence or absence of an occupant in each seat 30.

The outdoor camera 146 is used to capture an image of the exterior surroundings of the autonomous vehicle MV. The outdoor camera 146 includes a CMOS sensor, for example. The image captured by the outdoor camera 146 is transmitted to the control device 100. By analyzing the image, the control device 100 locates an obstacle, a white line, etc., around the autonomous vehicle MV. This allows the vehicle controller 130 to automatically perform, for example, steering and braking operations to avoid collision with the obstacle and steering operations for traveling along a traffic lane.

Furthermore, the outdoor camera 146 according to the present embodiment is capable of sensing the presence of a nearby vehicle around (in front of, behind, and on both the left and right sides of) the autonomous vehicle MV. A plurality of outdoor cameras 146 may be provided to capture images in respective directions. In order to sense the presence of a nearby vehicle, another device (for example, radar) different from the outdoor camera 146 may be included in the autonomous vehicle MV.

The speed sensor 147 is used for sensing the travel speed of the autonomous vehicle MV. The travel speed sensed by the speed sensor 147 is transmitted to the control device 100.

The operating unit 148 is a portion which, in order to cause the autonomous vehicle MV to start autonomous driving, an occupant in the interior operates. In the present embodiment, the operating unit 148 is configured as a push-button switch. Instead of this implementation, the operating unit 148 may be configured as a touch-panel device or a speech recognition device, for example.

There is a possibility that an occupant in the interior may unlock the safety device during autonomous driving of the autonomous vehicle MV. In such a case, the safety device does not function, exposing the bodies of occupants to dangers in the event of an accident such as rear-end collision with a nearby vehicle.

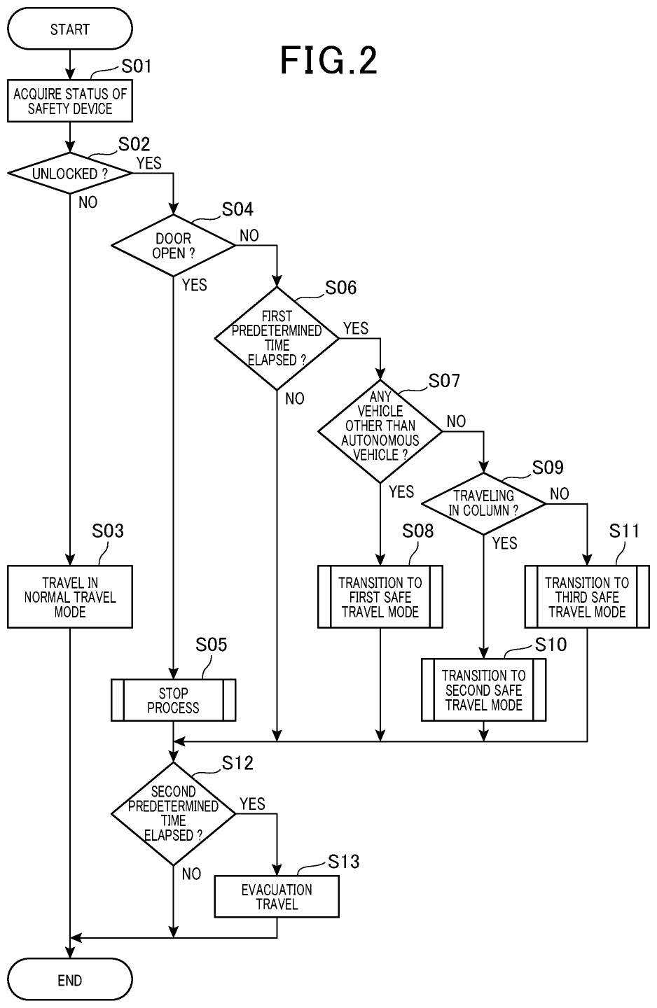

Therefore, the control device 100 according to the present embodiment switches from the normal mode to the safe travel mode as necessary to prevent accidents in the state where the safety device has been unlocked, for example, ensuring the safety of occupants. Specific details of the processes performed for this purpose are described with reference to FIG. 2.

A series of processes shown in FIG. 2 is repeatedly performed by the control device 100 every time a predetermined control period elapses. The following describes an example in which the series of processes shown in FIG. 2 is performed in a situation where control device 100 performs the autonomous driving operation.

In the first step, i.e., step S01, the device status sensor 120 acquires the status of each safety device. In step S02 subsequent to step S01, whether any safety device (except for the seat belt 31 in the seat 30 in which no occupant has been seated) has been unlocked is determined. When there is no safety device that has been unlocked, the process flow proceeds to step S03.

In step S03, the process of switching to the normal travel mode is performed. Note that when the normal travel mode has already been implemented at the proceed to step S03, the implementation of the normal travel mode continues thereafter.

In step S02, when any safety device has been unlocked, the process flow proceeds to step S04. In step S04, whether any door 20 is open is determined. When any door 20 is open, the process flow proceeds to step S05. In this case, there is a possibility that even during travel of the autonomous vehicle MV, an occupant may exit through the door 20 that is open.

Therefore, in step S05, a process for stopping the autonomous vehicle MV (stop process) is performed. This stop process is for not only stopping the autonomous vehicle MV so that the occupant who has exited will not be injured, but also preventing a nearby vehicle from colliding with the occupant. The stop process is one safe travel mode in the present embodiment. Specific implementation of the stop process will be described later. When the stop process in step S05 is completed, the process flow proceeds to step S12 to be described later.

When no door 20 is open in step S04, the process flow proceeds to step S06. In step S06, whether a first predetermined time has elapsed since the first sensing in step S02 of the entry into the status where the safety device has been unlocked is determined. The first predetermined time is set in advance as a grace period of time between unlocking of the safety device and switching to the safe travel mode. The first predetermined time may have a different length for each type of the safety device that has been unlocked. For example, the first predetermined time for the seat belt 31 may be set to zero seconds, and the first predetermined time for the locking mechanism 21 may be set to 10 seconds. Furthermore, the first predetermined time for a too large recline angle of the seat 30 may be set to 15 seconds.

When the first predetermined time has not elapsed in step S06, no particular process is performed, and the process flow proceeds to step S12 to be described later. When the first predetermined time has elapsed, the process flow proceeds to step S07. In step S07, whether another vehicle (a nearby vehicle) that is not an autonomous vehicle is present in a predetermined range around the autonomous vehicle MV is determined. When a nearby vehicle that is not an autonomous vehicle is present in the predetermined range, the process flow proceeds to step S08.

In step S08, a process in which the processing transitions to one safe travel mode, namely, a first safe travel mode, is performed. The first safe travel mode is a process of extending the inter-vehicle distance or changing traffic lanes, for example, in order to prevent, for example, rear-end collision with a nearby vehicle (in particular, a vehicle that is not an autonomous vehicle). Specific implementation of the first safe travel mode will be described later. When the process in which the processing transitions to the first safe travel mode is completed in step S08, the process flow proceeds to step S12 to be described later.

When it is determined in step S07 that a nearby vehicle that is not an autonomous vehicle is not present, the process flow proceeds to step S09. In step S09, whether the autonomous vehicle MV is traveling in a column together with another nearby autonomous vehicle is determined. The “traveling in a column” represents traveling of a plurality of autonomous vehicles all forming a column while exchanging information with each other through inter-vehicle communication.

Thus, when a nearby autonomous vehicle is traveling close to the autonomous vehicle MV, the vehicle controller 130 can cause the autonomous vehicle MV to travel in a column together with one or more nearby autonomous vehicles by performing the inter-vehicle communication with the one or more nearby autonomous vehicles.

When the autonomous vehicle MV is determined as traveling in a column in step S09, the process flow proceeds to step S10. In step S10, a process in which the processing transitions to one safe travel mode, namely, a second safe travel mode, is performed. The second safe travel mode is a process of changing the position of the autonomous vehicle MV in the column as necessary in order to prevent, for example, rear-end collision with another vehicle approaching the autonomous vehicle MV from outside the column. Specific implementation of the second safe travel mode will be described later. When the process in which the processing transitions to the second safe travel mode is completed in step S10, the process flow proceeds to step S12 to be described later.

When the autonomous vehicle MV is determined as not traveling in a column in step S09, the process flow proceeds to step S11. In step S11, a process in which the processing transitions to another safe travel mode, namely, a third safe travel mode, is performed. The third safe travel mode is for allowing a nearby autonomous vehicle to travel in a safe condition by performing the inter-vehicle communication with the nearby autonomous vehicle. The “safety condition” represents a condition where collision of a nearby autonomous vehicle with the autonomous vehicle MV or an occupant that has exited therefrom is prevented. Specific implementation of the third safe travel mode will be described later. When the process in which the processing transitions to the third safe travel mode is completed in step S11, the process flow proceeds to step S12 to be described later.

In step S12, whether a second predetermined time has elapsed since the first sensing in step S02 of the entry into the status where the safety device has been unlocked is determined. The second predetermined time is set in advance to a length greater than the length of the first predetermined time described earlier. When the second predetermined time has not elapsed, no particular process is performed, and the series of processes shown in FIG. 2 ends. When the second predetermined time has elapsed, the process flow proceeds to step S13.

The proceed to step S13 means that the safety device has been unlocked and even after transition to one safe travel mode, the safety device remains unlocked. In such a state, continuation of the travel of the autonomous vehicle MV is not preferred from a safety perspective. Thus, in step S13, a process for effecting evacuation travel of the autonomous vehicle MV is performed. The “evacuation travel” is a process for causing the autonomous vehicle MV to move to and stop at a relatively safe spot. Note that when the autonomous vehicle MV is already not in motion at a safe spot at the proceed to step S13, this state will be maintained thereafter.

Note that the second predetermined time which is used in the determination at step S12 may be always fixed to the same length or duration, but may also be changed in length depending on the situation. For example, when the travel speed of the autonomous vehicle MV is high, the second predetermined time may be set to be short, and when the travel speed of the autonomous vehicle MV is low, the second predetermined time may be set to be long. This is because when the travel speed of the autonomous vehicle MV is low, a distance the autonomous vehicle MV travels per unit of time is short, and thus the probability of collision with a nearby vehicle is low even when the second predetermined length is set to be long.

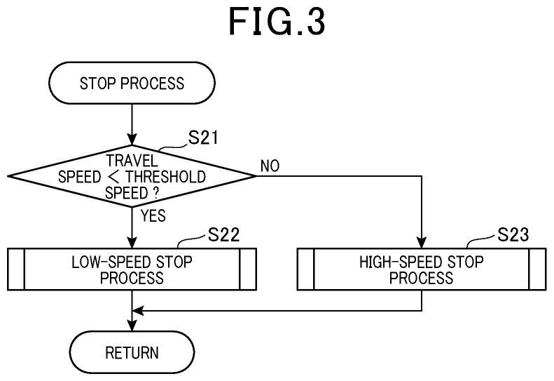

Specific details of the top process which is performed in step S05 are described. The flowchart in FIG. 3 shows the flow of processes performed by the control device 100 in the stop process.

In the first step, i.e., step S21, whether the travel speed of the autonomous vehicle MV is less than a predetermined threshold speed is determined. When the travel speed is less than the threshold speed, the process flow proceeds to step S22, and a low-speed stop process is performed. On the other hand, when the travel speed is greater than or equal to the threshold speed, the process flow proceeds to step S23, and a high-speed stop process is performed. In this manner, in the present embodiment, two types of stop process, namely, the low-speed stop process and the high-speed stop process, are prepared in advance and selectively performed according to the travel speed.

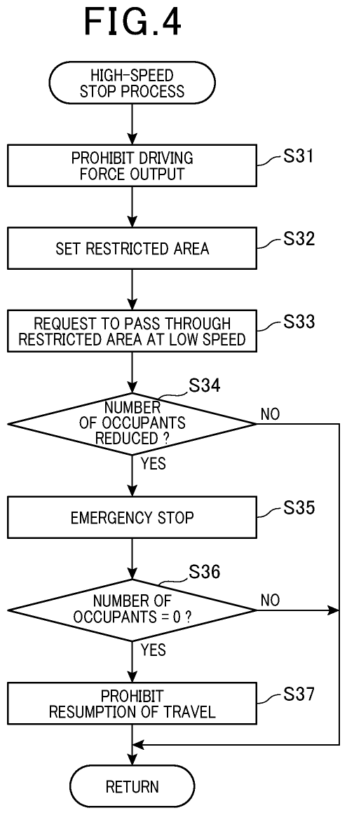

First, implementation of the high-speed stop process performed in step S23 is described. The flowchart in FIG. 4 shows the flow of processes performed by the control device 100 in the high-speed stop process.

In the first step, i.e., step S31, the process of prohibiting driving force output is performed on the driving force control device 60. Thereafter, the driving force from the driving device is no longer output. Note that instead of this process, the process of shifting the gear position of the transmission 70 to neutral may be performed.

After the process in step S31 is performed, a process for slowly decelerating and stopping the autonomous vehicle MV is performed in parallel with the process in step S32 and the subsequent processes to be described next. This process is performed by controlling the electric power steering device 40. At this time, the hazard lights 80 may flash to warn nearby vehicles.

In step S32 subsequent to step S31, the process of setting a restricted area is performed. The “restricted area” represents a region set in a predetermined range around the autonomous vehicle MV. FIG. 5 shows an example of a restricted area DA set around the autonomous vehicle MV that is traveling when viewed from above. As will be described later, the restricted area DA is set as a region for ensuring the safety of occupants by prohibiting or restricting travel of nearby vehicles.

The line denoted by a reference sign RL in FIG. 5 is a white line painted on a road surface to define a plurality of lanes (traffic lanes). Hereinafter, each white line will be referred to also as a “white line RL”. FIG. 5 shows: a lane L1 which is a “travel lane” in which the autonomous vehicle MV is traveling; a lane L0 which is a left-hand lane (in FIG. 5, an upper lane) adjacent to the lane L1; and a lane L2 which is a right-hand lane (in FIG. 5, a lower lane) adjacent to the lane L1.

The restricted area DA in the example of FIG. 5 expands backward from a front end portion of the autonomous vehicle MV and expands across the lanes L0 and L2 located on both left and right sides.

The description is continued with reference back to FIG. 4. In step S33 subsequent to step S32, the process of requesting a nearby vehicle to pass through the restricted area DA at a low relative speed is performed. The request is transmitted from the communication unit 110 to the nearby vehicle through the inter-vehicle communication. Note that the request can be received only by a nearby autonomous vehicle among nearby vehicles.

Thereafter, the relative speed of a nearby vehicle passing through the restricted area DA in FIG. 5 is low, and thus even if an occupant falls out through the door 20 that is open, the nearby vehicle is more likely to avoid colliding with the occupant. Note that in order to more reliably ensure the safety of occupants, the process of requesting a nearby vehicle not to enter the restricted area DA may be performed in step S32.

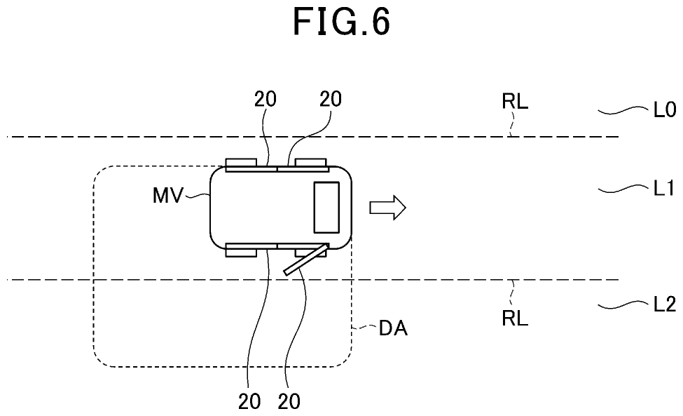

The restricted area DA may be different from that illustrated in FIG. 5. For example, as in the example illustrated in FIG. 6, when the door 20 on the front right side is opened, the restricted area DA is set to include a region on the right-hand side of the autonomous vehicle MV while a region on the left-hand side of the autonomous vehicle MV is not included in the restricted area DA. In other words, the restricted area DA may be set only in a region where an occupant may fall out through the door 20 that is open. Influences on the travel of a nearby vehicle can be reduced as a result of setting the restricted area DA according to the position of the door 20 that is open.

The description is continued with reference back to FIG. 4. In step S34 subsequent to step S33, whether the number of occupants in the interior is lower than that counted immediately after unlocking of the safety device is determined. The determination is made by analyzing an image captured by the indoor camera 145. When the number of occupants has not been reduced, the series of processes shown in FIG. 4 ends. In this case, the autonomous vehicle MV continues to slowly decelerate and is eventually stopped.

When the number of occupants has been reduced in step S34, the process flow proceeds to step S35. In this case, since an occupant has fallen out through the door 20 that is open, the process of urgently stopping the autonomous vehicle MV by braking hard is performed.

In step S36 subsequent to step S35, whether the number of occupants present in the interior is zero is determined. When the number of occupants is not zero, the series of processes shown in FIG. 4 ends. When the number of occupants is zero, the process flow proceeds to step S37. In step S37, the process of prohibiting resumption of the travel of the autonomous vehicle MV is performed. Thus, the autonomous vehicle MV is prevented from starting to travel, leaving any occupant behind.

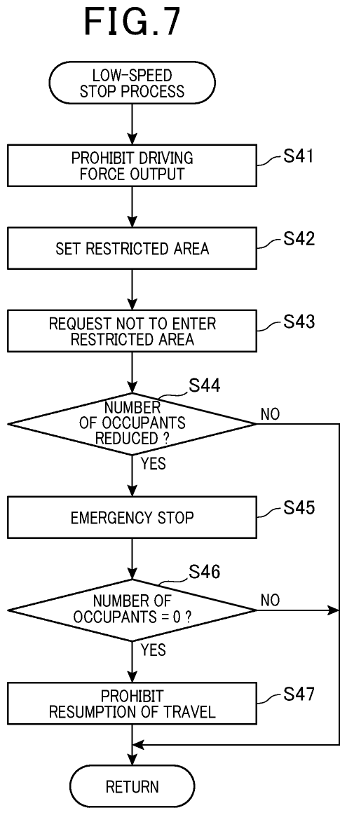

Next, implementation of the low-speed stop process performed in step S22 in FIG. 3 is described. The flowchart in FIG. 7 shows the flow of processes performed by the control device 100 in the low-speed stop process.

The process performed in the first step, i.e., step S41, is substantially the same as the process performed in step S31 in FIG. 4. Also, after step S41, the process for slowly decelerating and stopping the autonomous vehicle MV is performed in parallel. The deceleration at this time may be lower than that in the high-speed stop process.

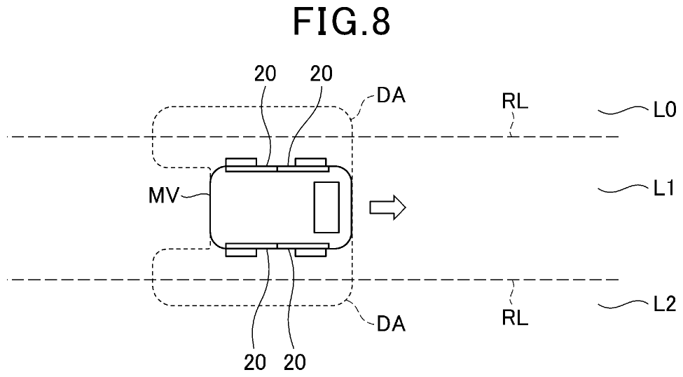

The process performed in step S42 subsequent to step S41 is substantially the same as the process performed in step S32 in FIG. 4. Note that the range of the restricted area DA that is set at this time may be changed according to the travel speed of the autonomous vehicle MV. For example, as in the example shown in FIG. 8, the restricted area DA in the low-speed stop process may be set to be narrower than the restricted area DA in the high-speed stop process (FIG. 5).

In step S43 subsequent to step S42, the process of requesting a nearby vehicle not to enter the restricted area DA is performed. The reason why the request for not entering the restricted area DA instead of passing therethrough at a low speed is made is that the likelihood of an occupant exiting from the autonomous vehicle MV on his or her own will is considered to be higher than in the case of the high-speed travel.

Note that instead of this implementation, the process of making a request for passing through the restricted area DA at a low relative speed as in the case of the high-speed stop process may be performed. In this case, the value of the “relative speed” may be changed according to the travel speed of the autonomous vehicle MV. For example, another vehicle may be requested to pass at a relative speed that is reduced as the travel speed is reduced.

The processes subsequent to step S43, specifically, the processes performed in steps S44 to S47, are the same as the processes performed in steps S34 to S37 in FIG. 4. Therefore, description of these processes is omitted.

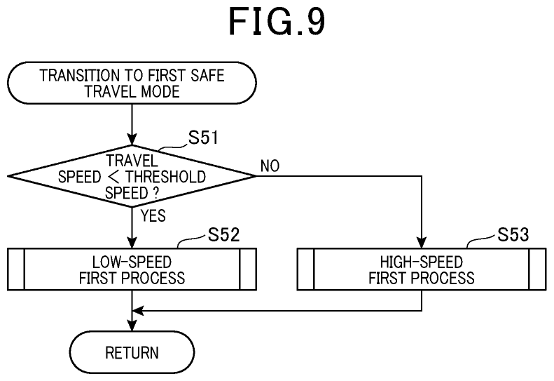

Specific details of the first safe travel mode to which the processing transitions in step S08 in FIG. 2 are described. The flowchart in FIG. 9 shows the flow of processes performed by the control device 100 in the first safe travel mode.

In the first step, i.e., step S51, whether the travel speed of the autonomous vehicle MV is less than a predetermined threshold speed is determined. When the travel speed is less than the threshold speed, the process flow proceeds to step S52, and a low-speed first process is performed. On the other hand, when the travel speed is greater than or equal to the threshold speed, the process flow proceeds to step S53, and a high-speed first process is performed. In this manner, in the present embodiment, two types of process in the first safe travel mode, namely, the low-speed first process and the high-speed first process, are prepared in advance and selectively performed according to the travel speed.

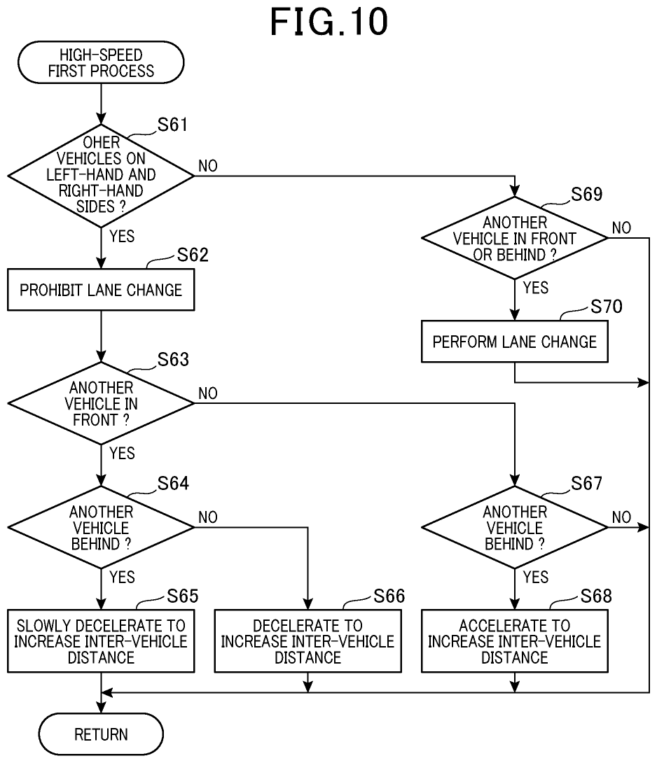

First, implementation of the high-speed first process performed in step S53 is described. The flowchart in FIG. 10 shows the flow of processes performed by the control device 100 in the high-speed first process.

In the first step, i.e., step S61, whether nearby vehicles are traveling on both the left and right sides of the autonomous vehicle MV is determined. This determination is made by analyzing an image captured by the outdoor camera 146. When nearby vehicles are traveling on both the left and right sides of the autonomous vehicle MV, the process flow proceeds to step S62. At this time, the autonomous vehicle MV is sandwiched between the nearby vehicles from both the left and right sides. Therefore, in step S62, the process of prohibiting the autonomous vehicle MV from changing lanes is performed.

In step S63 subsequent to step S62, whether a nearby vehicle is traveling in a predetermined range in front of the autonomous vehicle MV is determined. This determination is made by analyzing an image captured by the outdoor camera 146. When a nearby vehicle is traveling in front of the autonomous vehicle MV, the process flow proceeds to step S64.

In step S64, whether a nearby vehicle is traveling in a predetermined range behind the autonomous vehicle MV is determined. This determination is made by analyzing an image captured by the outdoor camera 146. When a nearby vehicle is traveling behind the autonomous vehicle MV, the process flow proceeds to step S65.

In step S65, in order to increase the inter-vehicle distance to the nearby vehicle in front, the vehicle controller 130 performs the process of temporarily decelerating the autonomous vehicle MV. Note that in the case where the processing has proceeded to step S65, a nearby vehicle is present not only in front of the autonomous vehicle MV, but also behind the autonomous vehicle MV. Therefore, in order to prevent rear-end collision with the nearby vehicle behind, the electric brake device 50 is controlled to make the deceleration slower than when the nearby vehicle is not present (in the case in step S66 to be described later).

In step S64, when no nearby vehicle is traveling in the backward predetermined range, the process flow proceeds to step S66. Also in step S66, the vehicle controller 130 performs the process of temporarily decelerating the autonomous vehicle MV to increase the inter-vehicle distance to the nearby vehicle in front. Note that the deceleration of the autonomous vehicle MV at this time is greater than the deceleration of the autonomous vehicle MV in step S65.

When no nearby vehicle is traveling in front of the autonomous vehicle MV in step S63, the process flow proceeds to step S67. In step S67, whether a nearby vehicle is traveling in a predetermined range behind the autonomous vehicle MV is determined. This determination is made by analyzing an image captured by the outdoor camera 146. The absence of a nearby vehicle traveling behind the autonomous vehicle MV means the absence of nearby vehicles in front of and behind the autonomous vehicle MV. In this case, there is no probability of rear-end collision of the autonomous vehicle MV with a nearby vehicle. Therefore, no particular process is performed, and the series of processes shown in FIG. 10 ends.

When a nearby vehicle is traveling behind the autonomous vehicle MV in step S67, the process flow proceeds to step S68. In step S68, in order to increase the inter-vehicle distance to the nearby vehicle behind, the vehicle controller 130 performs the process of temporarily accelerating the autonomous vehicle MV.

When no nearby vehicle is traveling on at least one of the left and right sides of the autonomous vehicle MV in step S61, the process flow proceeds to step S69. In step S69, whether a nearby vehicle is traveling in one of a predetermined range in front of the autonomous vehicle MV and a predetermined range behind the autonomous vehicle MV is determined. When no nearby vehicle is traveling in front of or behind the autonomous vehicle MV, there is no probability of rear-end collision of the autonomous vehicle MV with a nearby vehicle. Therefore, no particular process is performed, and the series of processes shown in FIG. 10 ends.

When a nearby vehicle is traveling in front of or behind the autonomous vehicle MV in step S69, the process flow proceeds to step S70. In step S70, the processing of changing the travel lane for the autonomous vehicle MV to a lane different from the current travel lane (which can be referred to as a travel lane used in the normal travel mode) is performed. In other words, the process of causing the autonomous vehicle MV to change lanes is performed. The lane in which the autonomous vehicle MV travels after the lane change is the lane determined as not including nearby vehicles in step S61.

As described above, when the high-speed first process is performed as the safe travel mode, the inter-vehicle distance to a nearby vehicle traveling in front of or behind the autonomous vehicle MV is set to be greater than in the normal travel mode. This reduces the probability of contact between the autonomous vehicle MV and a nearby vehicle traveling in front of or behind the autonomous vehicle MV. As a result, even in the state where the safety device has been unlocked, the safety of occupants can be ensured to some extent.

Stated differently, this safe travel mode is set as a travel mode in which the inter-vehicle distance between the autonomous vehicle MV and a nearby vehicle traveling close to the autonomous vehicle MV is made greater than the inter-vehicle distance in the normal travel mode.

During execution of the high-speed first process which is the safe travel mode, when another vehicle is traveling in the predetermined range behind the autonomous vehicle MV, the vehicle controller 130 decelerates the autonomous vehicle MV more slowly than when said other vehicle is not present (steps S64, S65). Consequently, the autonomous vehicle MV is prevented from rear-end collision from behind along with the deceleration.

Note that the proceed o step S65 means that the autonomous vehicle MV is surrounded by nearby vehicles in front of, behind, and both the left and right sides of the autonomous vehicle MV. The deceleration in such a state may be performed to increase the inter-vehicle distance to the nearby vehicle in front as described above, but may be performed for the purpose of reducing both the travel speed of the autonomous vehicle MV and the travel speed of the nearby vehicle behind the autonomous vehicle MV. This is because, when the travel speed of each of these vehicles is reduced, the probability of rear-end collision of the autonomous vehicle MV from behind is also reduced. Also when the determination result in step S67 is negative, the autonomous vehicle MV may be decelerated for this purpose.

Thus, the safe travel mode may be set as a travel mode in which the travel speed of the autonomous vehicle MV is set less than the travel speed used during implementation of the normal travel mode. In this case, the vehicle controller 130 may be configured to perform the process of reducing the travel speed of the autonomous vehicle MV when another vehicle is traveling in each of the predetermined range behind the autonomous vehicle MV and the predetermined range in lanes adjacent to(in other words, the lanes on both the left and right sides of) the travel lane for the autonomous vehicle MV (in other words, when a safe lane change is difficult).

In the example described above, the vehicle controller 130 increases the inter-vehicle distance to a nearby vehicle by changing the travel speed, the travel lane, etc., of the autonomous vehicle MV. Instead of this implementation, the vehicle controller 130 may perform inter-vehicle communication with a nearby vehicle and cause a change in the position of the nearby vehicle to increase the inter-vehicle distance between the nearby vehicle and the autonomous vehicle MV.

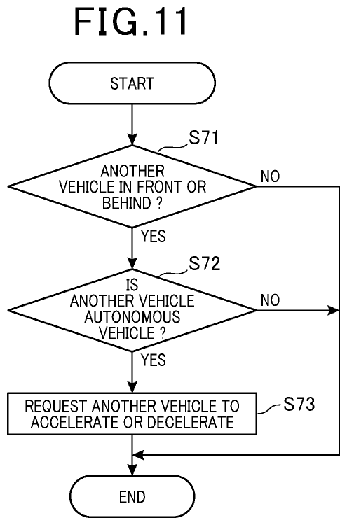

An example of the process performed for this purpose is described with reference to FIG. 11. A series of processes shown in FIG. 11 may be performed by the vehicle controller 130 instead of the series of processes shown in FIG. 10 or may be performed by the vehicle controller 130 in parallel with the series of processes shown in FIG. 10.

In the first step, i.e., step S71, whether a nearby vehicle is traveling in one of a predetermined range in front of the autonomous vehicle MV and a predetermined range behind the autonomous vehicle MV is determined. When no nearby vehicle is traveling in front of or behind the autonomous vehicle MV, there is no probability of collision between the autonomous vehicle MV and a nearby vehicle. Therefore, no particular process is performed, and the series of processes shown in FIG. 11 ends.

When a nearby vehicle is traveling in front of or behind the autonomous vehicle MV in step S71, the process flow proceeds to step S72. In step S72, whether the nearby vehicle is an autonomous vehicle is determined. When the nearby vehicle is not an autonomous vehicle, the series of processes shown in FIG. 11 ends. In this case, the processes shown in FIG. 10 are performed, and thus the inter-vehicle distance to the nearby vehicle is increased.

When a nearby vehicle traveling in front or behind the autonomous vehicle MV is an autonomous vehicle in step S72, the process of performing the inter-vehicle communication with the nearby vehicle (that is, the nearby autonomous vehicle) and thereby requesting the nearby vehicle to accelerate or decelerate is performed. When the nearby vehicle is traveling in front of the autonomous vehicle MV, the process of requesting the nearby vehicle to accelerate is performed. On the other hand, when the nearby vehicle is traveling behind the autonomous vehicle MV, the process of requesting the nearby vehicle to decelerate is performed. Thus, the inter-vehicle distance between the nearby vehicle and the autonomous vehicle MV is increased.

Next, implementation of the low-speed first process performed in step S52 in FIG. 9 is described. Details of the low-speed first process are roughly the same as details of the high-speed first process described with reference to FIG. 10, etc. Therefore, only differences from the high-speed first process are described below.

In the low-speed first process, the series of processes shown in FIG. 10 may be performed in the state where the driving force to be output is limited to a predetermined level or less so that the travel speed of the autonomous vehicle MV will not further increase.

Furthermore, in the low-speed first process, on the condition that the difference in speed from a nearby vehicle traveling in a left-side lane on the shoulder side (in the example of FIG. 5, the lane L0) is small, a lane change for movement to said lane may be performed. This is because the movement in advance to a lane in which relatively low-speed vehicles are traveling makes it easier to ensure the safety of occupants in the state where the safety device has been unlocked.

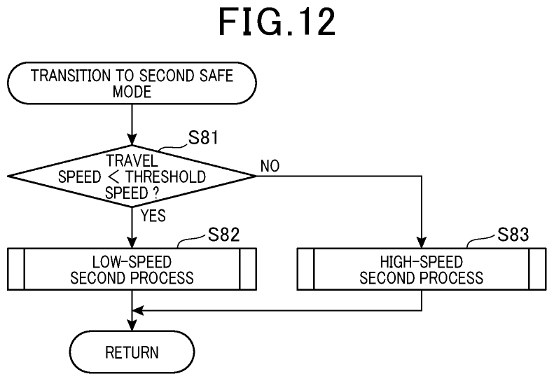

Specific details of the second safe travel mode to which the processing transitions in step S10 in FIG. 2 are described. The flowchart in FIG. 12 shows the flow of processes performed by the control device 100 in the second safe travel mode.

In the first step, i.e., step S81, whether the travel speed of the autonomous vehicle MV is less than a predetermined threshold speed is determined. When the travel speed is less than the threshold speed, the process flow proceeds to step S82, and a low-speed second process is performed. On the other hand, when the travel speed is greater than or equal to the threshold speed, the process flow proceeds to step S83, and a high-speed second process is performed. In this manner, in the present embodiment, two types of process in the second safe travel mode, namely, the low-speed second process and the high-speed second process, are prepared in advance and selectively performed according to the travel speed.

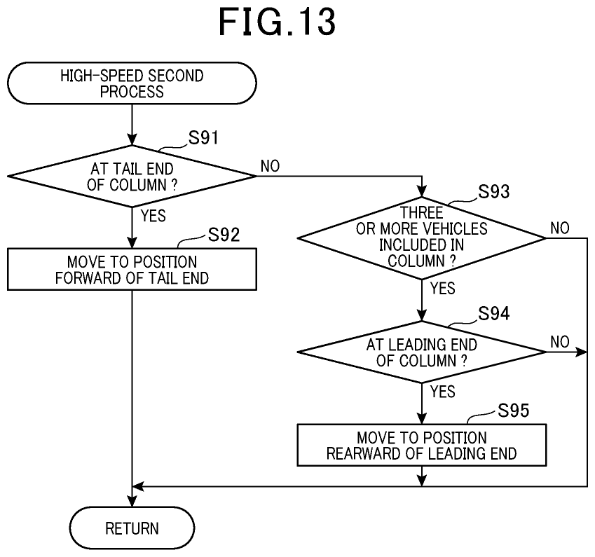

First, implementation of the high-speed second process performed in step S83 is described. The flowchart in FIG. 13 shows the flow of processes performed by the control device 100 in the high-speed second process.

As described earlier, upon execution of the high-speed second process, only the nearby autonomous vehicle is traveling around the autonomous vehicle MV, and the autonomous vehicle MV is traveling in a column together with the nearby autonomous vehicle.

In the first step, i.e., step S91, whether the autonomous vehicle MV is traveling at a position at the tail end of the column is determined. When the autonomous vehicle MV is traveling at the position at the tail end of the column, the process flow proceeds to step S92.

The position at the tail end of the column is a position in which there is a probability of rear-end collision with a nearby vehicle traveling behind the column, especially, a nearby vehicle that is not an autonomous vehicle. Thus, in step S92, the process of changing the position of the autonomous vehicle MV in the column to a position forward of the tail end is performed. Such a change in the position can be achieved, for example, by a lane change, acceleration, or the like of the autonomous vehicle MV. Note that the “position forward of the tail end” is the position in the second last place in the column or a position forward thereof. As a result of causing the autonomous vehicle MV to travel at such a position in a column, the probability of rear-end collision of the autonomous vehicle MV with a nearby vehicle can be reduced.

In step S91, when the autonomous vehicle MV is traveling at a position different from the position at the tail end of the column, the process flow proceeds to step S93. In step S93, whether the number of vehicles (including the autonomous vehicle MV) forming the column is three or more is determined. When the number of vehicles is two, the series of processes shown in FIG. 13 ends. When the number of vehicles is three or more, the process flow proceeds to step S94.

In step S94, whether the autonomous vehicle MV is traveling at a position at the leading end of the column is determined. When the autonomous vehicle MV is traveling at a position different from the leading end of the column, the series of processes shown in FIG. 13 ends. When the autonomous vehicle MV is traveling at the position at the leading end of the column, the process flow proceeds to step S95.

The position at the leading end of the column is a position in which there is a probability of collision with the rear end of a nearby vehicle traveling ahead in the column, especially, a nearby vehicle that is not an autonomous vehicle, during hard braking of the nearby vehicle. Thus, in step S95, the process of changing the position of the autonomous vehicle MV in the column to a position rearward of the leading end is performed. Such a change in the position can be achieved, for example, by a lane change, deceleration, or the like of the autonomous vehicle MV. Note that the “position rearward of the leading end” is the position in the second front place in the column or a position rearward thereof. As a result of causing the autonomous vehicle MV to travel at such a position in a column, the probability of collision of the autonomous vehicle MV with the rear end of a nearby vehicle can be reduced.

As described above, when the high-speed second process is performed as the safe travel mode, the position in which the autonomous vehicle MV is traveling is changed to a position internal to the column. This reduces the probability of contact between the autonomous vehicle MV and a nearby vehicle traveling outside the column. As a result, even in the state where the safety device has been unlocked, the safety of occupants can be ensured to some extent.

In other words, this safe travel mode is a travel mode for positioning the autonomous vehicle MV traveling in a column in the second last place in the column or in a place forward thereof (step S92). At this time, the vehicle controller 130 causes the autonomous vehicle MV to travel, if possible, at the position in the second front place in the column or at a position rearward thereof (step S95). This allows the autonomous vehicle MV to travel in a safer position.

In the example described above, the vehicle controller 130 causes the autonomous vehicle MV to change lanes or decelerate, for example, to change the position of the autonomous vehicle MV in the column. Instead of this implementation, the vehicle controller 130 may perform the inter-vehicle communication with a nearby vehicle to change the travel position of the autonomous vehicle MV in the column without changing the travel lane for the autonomous vehicle MV.

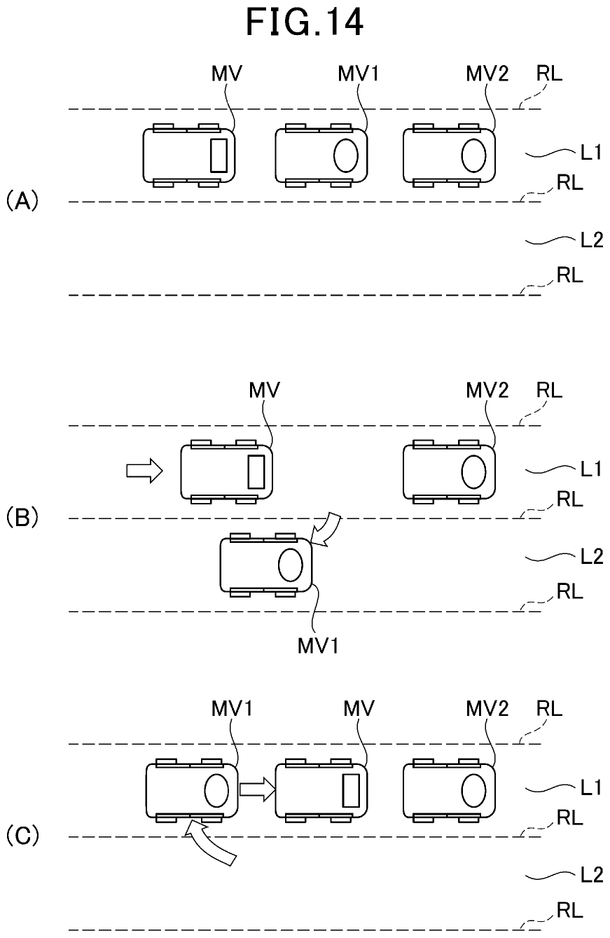

An example of the process performed for this purpose is described with reference to FIG. 14. FIG. 14 shows, in (A), what a column looks like before the above-described position change. In the situation in (A) in FIG. 14, the column is formed of three vehicles, namely, the autonomous vehicle MV, a nearby autonomous vehicle MV1, and a nearby autonomous vehicle MV2. In this situation, the autonomous vehicle MV is traveling at the position at the tail end of the column. The nearby autonomous vehicle MV1 is traveling in front of the autonomous vehicle MV, and the nearby autonomous vehicle MV2 is traveling further ahead thereof. All these vehicles are traveling in a lane L1.

In the situation in (A) in FIG. 14, when an unlocked state of the safety device is detected, the vehicle controller 130 requests the nearby autonomous vehicle MV through the inter-vehicle communication to change traffic lanes. As shown in (B) in FIG. 14, following the request, the nearby autonomous vehicle MV1 changes traffic lanes and moves to a lane L2 located on the right-hand side of the lane L1. Accordingly, the vehicle controller 130 causes the autonomous vehicle MV to temporarily accelerate so that the position of the autonomous vehicle MV approaches the nearby autonomous vehicle MV2.

Thereafter, as shown in (C) in FIG. 14, the nearby autonomous vehicle MV1 changes traffic lanes to return from the lane L2 to the lane L1 and moves to a position behind the autonomous vehicle MV. As a result, the autonomous vehicle MV in the column is positioned between the nearby autonomous vehicle MV1 and the nearby autonomous vehicle MV2, in other words, is in a position internal to the column. When such a control is performed, the autonomous vehicle MV does not need to change lanes. Therefore, in the state where the safety device has been unlocked, the safety of occupants in the autonomous vehicle MV can be ensured to some extent.

Next, implementation of the low-speed second process performed in step S82 in FIG. 12 is described. Details of the low-speed second process are roughly the same as details of the high-speed second process described with reference to FIG. 13. Therefore, only differences from the high-speed second process are described below.

In the low-speed second process, the series of processes shown in FIG. 13 or the processes described with reference to FIG. 14 may be performed in the state where the driving force to be output is limited to a predetermined level or less so that the travel speed of the autonomous vehicle MV will not further increase.

During execution of the low-speed second process, an occupant is more likely to exit from the vehicle than during execution of the high-speed second process. Thus, a nearby autonomous vehicle is preferably caused to travel at a safer position so that even if an occupant exits from the vehicle, another vehicle will not collide with the occupant.

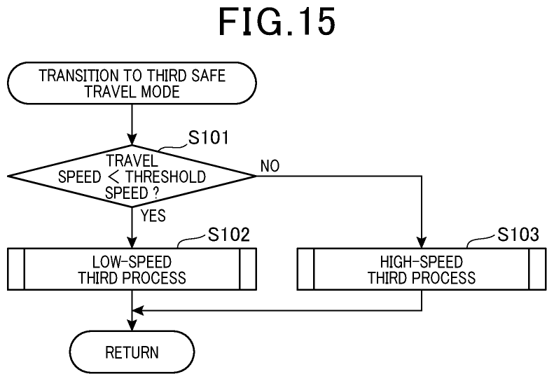

Specific details of the third safe travel mode to which the processing transitions in step S11 in FIG. 2 are described. The flowchart in FIG. 15 shows the flow of processes performed by the control device 100 in the third safe travel mode.

In the first step, i.e., step S101, whether the travel speed of the autonomous vehicle MV is less than a predetermined threshold speed is determined. When the travel speed is less than the threshold speed, the process flow proceeds to step S102, and a low-speed third process is performed. On the other hand, when the travel speed is greater than or equal to the threshold speed, the process flow proceeds to step S103, and a high-speed third process is performed. In this manner, in the present embodiment, two types of process in the third safe travel mode, namely, the low-speed third process and the high-speed third process, are prepared in advance and selectively performed according to the travel speed.

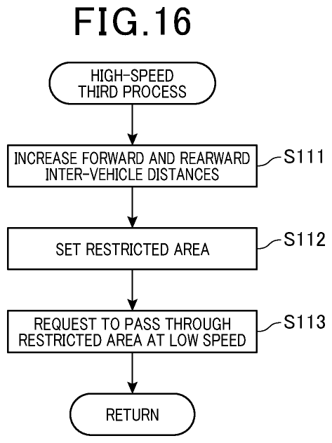

First, implementation of the high-speed third process performed in step S103 is described. The flowchart in FIG. 16 shows the flow of processes performed by the control device 100 in the high-speed third process.

As described earlier, upon execution of the high-speed third process, only nearby autonomous vehicles are traveling around the autonomous vehicle MV, and the autonomous vehicle MV is not traveling in a column.

In the first step, i.e., step S111, the process of setting the forward and backward inter-vehicle distances of the autonomous vehicle MV greater than during implementation of the normal travel mode. This process can be achieved by the vehicle controller 130 causing the autonomous vehicle MV to accelerate or decelerate or causing the autonomous vehicle MV to change lanes, for example. The vehicle controller 130 may increase the aforementioned inter-vehicle distances by performing the inter-vehicle communication with nearby autonomous vehicles traveling in front of and behind the autonomous vehicle MV to cause the nearby autonomous vehicles to change the travel positions thereof.

In step S112 subsequent to step S111, the process of setting the restricted area DA is performed. As described earlier with reference to FIG. 5, etc., the restricted area DA is set around the autonomous vehicle MV as a region for ensuring the safety of occupants by prohibiting or restricting travel of nearby vehicles. The range of the restricted area DA set herein may be the same as or different from that in the example shown in FIG. 5.

In step S113 subsequent to step S112, the process of transmitting a request for passing through the restricted area DA at a low relative speed to all the nearby autonomous vehicles through the inter-vehicle communication is performed. This process will be hereinafter referred to also as the “first request process”.

As a result of the first request process, the relative speed of a nearby autonomous vehicle passing through the restricted area DA is thereafter low, and thus even if an occupant falls out through the door 20 that is open, the nearby autonomous vehicle is more likely to avoid colliding with the occupant.

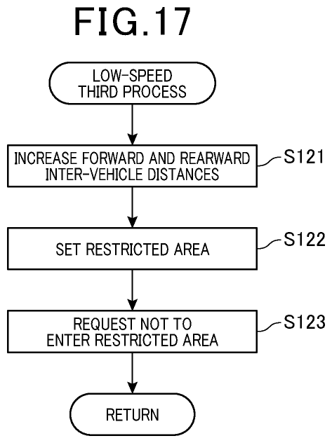

Next, implementation of the low-speed third process performed in step S102 in FIG. 15 is described. The flowchart in FIG. 17 shows the flow of processes performed by the control device 100 in the low-speed third process.

The process performed in the first step, i.e., step S121, is the same as the process performed in step S111 in FIG. 16. In step S122 subsequent to step S121, the process of setting the restricted area DA is performed, as in step S112 in FIG. 16. The range of the restricted area DA set at this time may be the same as or different from that of the restricted area DA set in the high-speed third process. For example, the range of the restricted area DA may be set narrower than the range of the restricted area DA set in the high-speed third process.

In step S123 subsequent to step S122, the process of transmitting a request for prohibiting entry into the restricted area DA to all the nearby autonomous vehicles through the inter-vehicle communication is performed. This process will be hereinafter referred to also as the “second request process”.

As a result of the second request process, a nearby autonomous vehicle is thereafter no longer traveling in the restricted area DA. Therefore, even if an occupant exits through the door 20 that is open, collision of the nearby autonomous vehicle with the occupant can be reliably prevented.

As described above, the third safe travel mode shown in FIGS. 16 and 17 is set as a travel mode in which, in the case where a nearby autonomous vehicle which is another autonomous vehicle is traveling close to the autonomous vehicle MV, the vehicle controller 130 performs one of the first request process of requesting the nearby autonomous vehicle to pass at a low relative speed through the restricted area DA set around the autonomous vehicle MV and the second request process of requesting the nearby autonomous vehicle not to enter the restricted area DA. As a result of this process, the probability of collision of a nearby vehicle with an occupant who has fallen or exited from the autonomous vehicle MV is reduced.

According to the travel speed of the autonomous vehicle MV, the vehicle controller 130 switches between performing the first request process and performing the second request process. Specifically, when the travel speed of the autonomous vehicle MV is greater than a predetermined speed (upon execution of the high-speed third process), the vehicle controller 130 performs the first request process, and when the travel speed of the autonomous vehicle MV is less than the predetermined speed (upon execution of the low-speed third process), the vehicle controller 130 performs the second request process. As a result of one of the first request process and the second request process being selectively performed according to the travel speed, the safety of occupants can be ensured while the influence on a nearby vehicle is minimized.

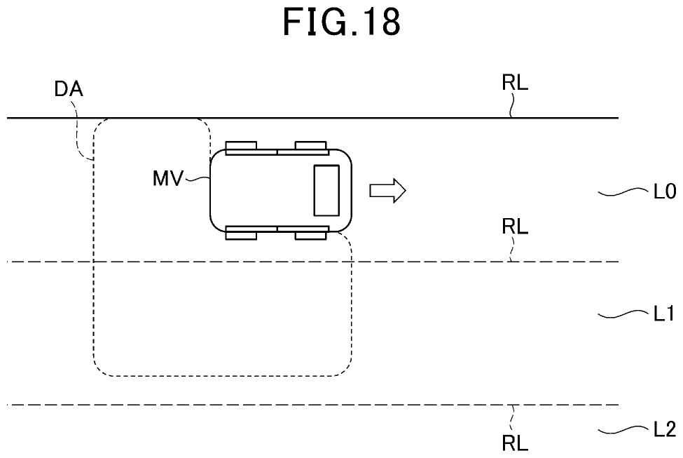

The restricted area DA which is set in step S112 in FIG. 16 and step S122 in FIG. 17 is not limited to the implementation so far described and can be set as a range of various shapes. In the example shown in FIG. 18, the autonomous vehicle MV is traveling in the leftmost lane L0, on the left-hand side of which no lane exists. In such a case, there is no likelihood that a nearby vehicle passes through a range located further to the left of the white line RL defining the left-hand side of the lane L0. Therefore, as shown in FIG. 18, the restricted area DA may be set as a range that does not cross over the white line RL. Similarly, the restricted area DA may be set as a range that does not cross over a boundary to the oncoming traffic lane.

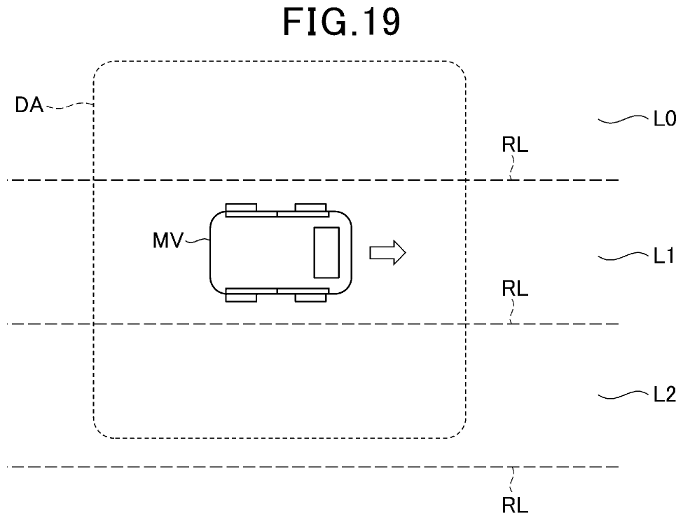

In the example shown in FIG. 19, the restricted area DA spreads both forward and backward of the autonomous vehicle MV and expands across the lanes L0 and L2 located on both the left and right sides. When the restricted area DA is set in this manner to include a range located ahead of the front end of the autonomous vehicle MV, the event of a nearby vehicle entering the range and suddenly stopping therein can be prevented.

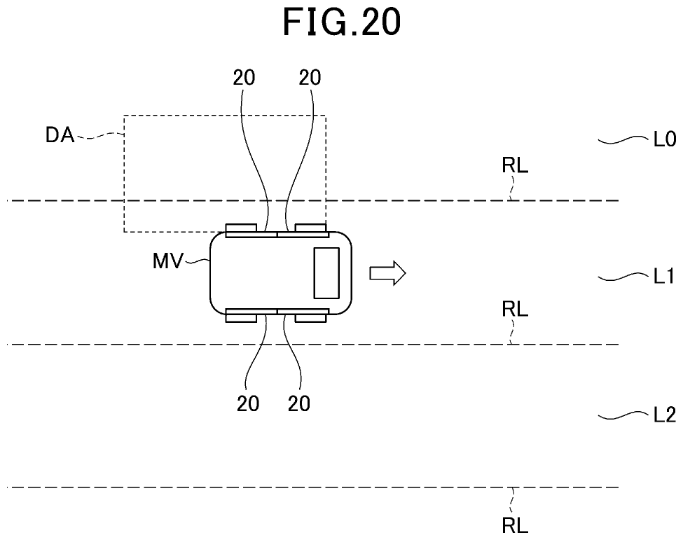

FIG. 20 shows an example of the restricted area DA set in the case where the seat belt 31 in the seat 30 on the front left side has been unlocked. In this case, an occupant who has unlocked the seat belt 31 may exit or fall from the vehicle, only on the side on which the seat belt 31 is provided, that is, on the left-hand side of the autonomous vehicle MV. Thus, in the example in FIG. 20, the restricted area DA is set only on the left-hand side of the autonomous vehicle MV and is not set on the right-hand side of the autonomous vehicle MV. This applies also to the case where the locking mechanism 21 on the front left side has been unlocked.

On the other hand, when the seat belt 31 and the locking mechanism 21 on the right-hand side have been unlocked, it is sufficient that the restricted area DA be set only on the right-hand side of the autonomous vehicle MV and not be set on the left-hand side of the autonomous vehicle MV.

Thus, with the vehicle controller 130 configured to set the restricted area DA according to the position of the safety device that has been unlocked, unnecessary limitations on the travel of a nearby vehicle can be prevented.

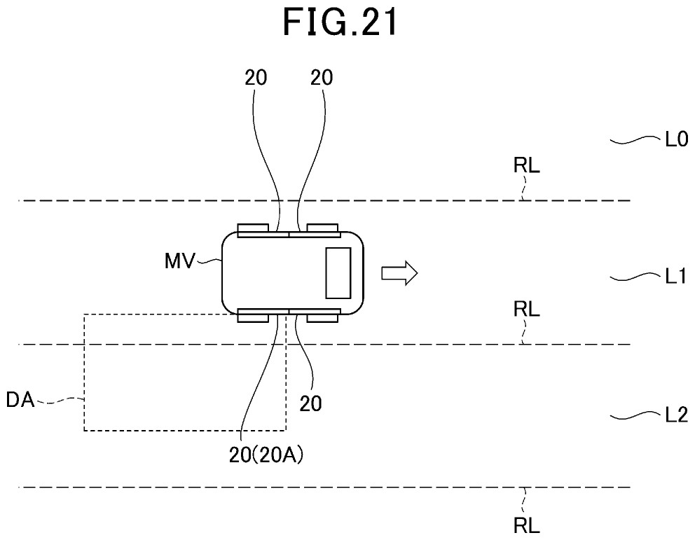

Note that the restricted area DA may be set in further consideration of the position of the safety device that has been unlocked. FIG. 21 shows an example of the restricted area DA set in the case where the seat belt 31 in the seat 30 on the back right side has been unlocked. In this case, an occupant who has unlocked the seat belt 31 may exit or fall from the vehicle, only through the door 20 on the back right side (denoted by a reference sign “20A” in FIG. 21); the occupant is unlikely to exit or fall from the vehicle through the other doors 20.

Therefore, in the example in FIG. 21, the restricted area DA is set only in a range covering the outer side of the door 20 on the back right side and the rearward side thereof. In other words, the restricted area DA is not set on the outer side of the door 20 on the front right side or on the left-hand side of the autonomous vehicle MV. Thus, the restricted area DA may be set only in the minimum range where an occupant may exit or fall from the vehicle.

As described above, in the control device 100 according to the present embodiment, in response to the device status sensor 120 sensing that the safety device has been unlocked, the vehicle controller 130 performs the process of switching from the normal travel mode to the safe travel mode. As a result, even in the case where the safety device has been unlocked during travel of the autonomous vehicle MV, the safety of occupants can be ensured to some extent.

Note that each of the normal travel mode and the safe travel mode in the above description is a travel mode implemented during autonomous driving of the autonomous vehicle MV. However, each of the normal travel mode and the safe travel mode may be a travel mode implemented during manual driving. For example, when the safety device is unlocked during manual driving (in the normal travel mode), the vehicle controller 130 may perform the first request process, the second request process, or the like on a nearby autonomous vehicle by performing the inter-vehicle communication with the nearby autonomous vehicle (while continuing the manual driving). In this case, the travel mode in which the first request process, the second request process, or the like is performed corresponds to the “safe travel mode” for manual driving.

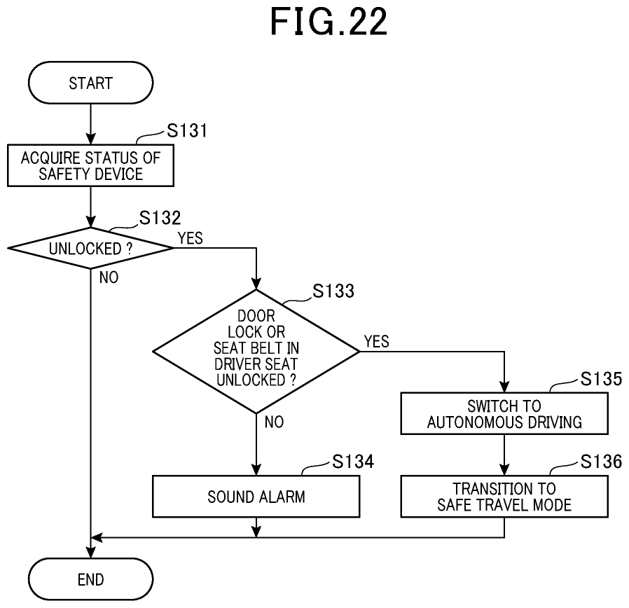

Aside from the above, processes performed by the control device 100 during manual driving are described with reference to FIG. 22. A series of processes shown in FIG. 22 is repeatedly performed by the control device 100 during manual driving of the autonomous vehicle MV.

In the first step, i.e., step S131, the device status sensor 120 acquires the status of each safety device. In step S132 subsequent to step S131, whether any safety device (except for the seat belt 31 in the seat 30 in which no occupant has been seated) has been unlocked is determined. When there is no safety device that has been unlocked, the series of processes shown in FIG. 22 ends.

In step S132, when any safety device has been unlocked, the process flow proceeds to step S133. In step S133, whether at least one of unlocking of the locking mechanism 21 and unlocking or release of the seat belt 31 in the driver seat has occurred is determined. When the determination result is “NO”, that is, when the seat belt 31 in at least one seat 30 other than the driver seat has been unlocked and the other safety devices have not been unlocked, the process flow proceeds to step S134. In step S134, the warning device 90 is operated to sound an alarm, and thus the process of prompting an occupant to fasten the seat belt 31 is performed.

When the determination result in step S133 is “YES”, that is, when at least one of unlocking of the locking mechanism 21 and unlocking of the seat belt 31 in the driver seat has occurred, the process flow proceeds to step S135.

In this case, in addition to the likelihood that an occupant may exit or fall from the vehicle through the door 20, there is also a likelihood that the driver may have left the driver seat. Thus, in step S135, the process of switching from manual driving to autonomous driving is performed. Furthermore, in step S136 subsequent to step S135, the process of switching from the normal travel mode to the safe travel mode is performed. This process is the process described earlier with reference to FIG. 2, etc. As a result of this process, even if an occupant has fallen or exited from the vehicle, the safety of the occupants can be ensured to some extent. Furthermore, even if the driver has left the driver seat, the autonomous vehicle MV can safely continue traveling.

Note that after the process in step S135 is performed, when a driver performs some driving operations (for example, operations on the steering handle, the brake pedal, and the like), the process of suspending autonomous driving and returning to manual driving is preferably performed.

As described above, in the present embodiment, in response to the device status sensor 120 sensing that the safety device (especially, the safety device installed to the driver seat) has been unlocked during travel of the autonomous vehicle MV through manual driving by the driver, the vehicle controller 130 performs the process of implementing the safe travel mode after switching from manual driving to autonomous driving. Thus, even if the safety device is unlocked during manual driving, the safety of occupants can be ensured.

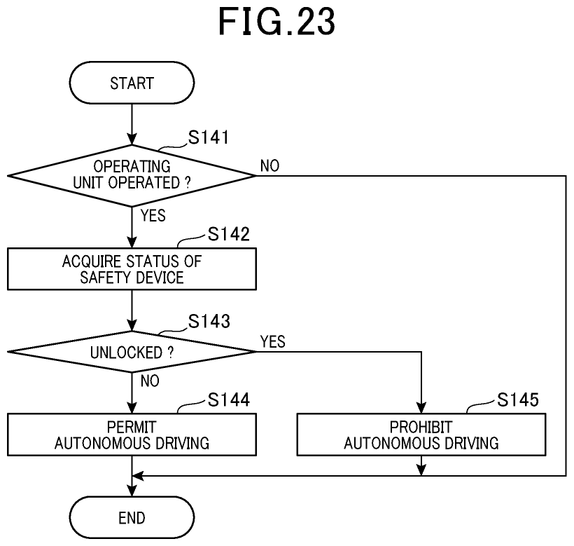

The other processes performed by the control device 100 during manual driving are described with reference to FIG. 23. A series of processes shown in FIG. 23 is repeatedly performed by the control device 100 in parallel with the processes in FIG. 22 during manual driving of the autonomous vehicle MV.

In the first step, i.e., step S141, whether the operating unit 148 has been operated by an occupant, that is, whether the operation for switching to autonomous driving has been performed by an occupant, is determined. When the operating unit 148 has not been operated, the series of processes shown in FIG. 23 ends. When the operating unit 148 has been operated, the process flow proceeds to step S142.

In step S142, the device status sensor 120 acquires the status of each safety device. In step S143 subsequent to step S142, whether any safety device (except for the seat belt 31 in the seat 30 in which no occupant has been seated) has been unlocked is determined. When there is no safety device that has been unlocked, the process flow proceeds to step S144. In step S144, the process of permitting autonomous driving is performed. Thereafter, the vehicle controller 130 performs the process of starting autonomous driving.

In step S143, when any safety device has been unlocked, the process flow proceeds to step S145. In step S145, the process of prohibiting autonomous driving is performed. In this case, the vehicle controller 130 does not perform the process of starting autonomous driving. Thus, manual driving continues thereafter.

As described above, when the operating unit 148 is operated and the device status sensor 120 senses that the safety device has been unlocked, the vehicle controller 130 does not perform the process of starting autonomous driving. This prevents autonomous driving from starting in a dangerous state with the safety device remaining unlocked.

The second embodiment is described. The present embodiment is the same as the first embodiment except for a portion of the processes performed by the control device 100. Hereinafter, differences from the first embodiment are mainly described, and description of the same features as in the first embodiment is omitted, as appropriate.

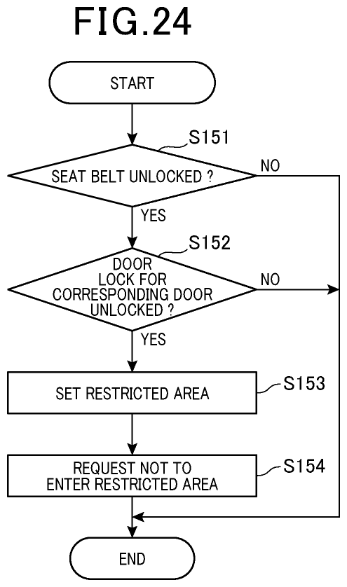

A series of processes shown in FIG. 24 is repeatedly performed by the control device 100, instead of the series of processes shown in FIG. 2, every time a predetermined control period has elapsed. Note that the series of processes shown in FIG. 24 may be performed in parallel with the series of processes shown in FIG. 2.

In the first step, i.e., step S151, whether any seat belt 31 (except for the seat belt 31 in the seat 30 in which no occupant has been seated) has been unlocked is determined. When there is no seat belt 31 that has been unlocked, the series of processes shown in FIG. 24 ends. When there is a seat belt 31 that has been unlocked, the process flow proceeds to step S152.

In step S152, whether the locking mechanism 21 for the door 20 corresponding to the unlocked seat belt 31 (that is, the door 20 closest to the seat 30 in which said seat belt 31 is provided) has been unlocked is determined. When the locking mechanism 21 has not been unlocked, the series of processes shown in FIG. 24 ends. When the locking mechanism 21 has been unlocked, the process flow proceeds to step S153.

In step S153, the process of setting the restricted area DA is performed. The restricted area DA is set in substantially the same manner as that described so far. The restricted area DA may be set as a range fixed in advance or may accordingly be set as a range corresponding to the position of the safety device that has been unlocked.

In step S154 subsequent to step S153, the process of transmitting a request for prohibiting entry into the restricted area DA to all the nearby autonomous vehicles through the inter-vehicle communication, that is, the second request process, is performed. Thereafter, nearby autonomous vehicles no longer travel in the restricted area DA. Thus, even if an occupant exits from the vehicle, collision of a nearby vehicle with the occupant can be reliably prevented.

As described above, in the present embodiment, in response to the device status sensor 120 sensing that both the seat belt 31 and the locking mechanism 21 have been unlocked, the vehicle controller 130 performs the second request process. In a situation in which an occupant is likely to exit or fall from the vehicle, nearby vehicles are prohibited from approaching the autonomous vehicle MV, and thus the safety of occupants can be further ensured.

The third embodiment is described. The present embodiment is the same as the first embodiment except for a portion of the processes performed by the control device 100. Hereinafter, differences from the first embodiment are mainly described, and description of the same features as in the first embodiment is omitted, as appropriate.

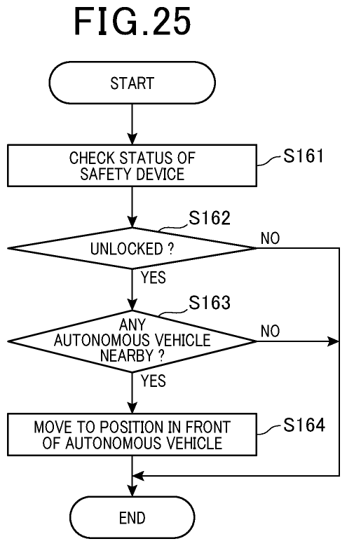

A series of processes shown in FIG. 25 is repeatedly performed by the control device 100, instead of the series of processes shown in FIG. 2, every time a predetermined control period has elapsed. Note that the series of processes shown in FIG. 25 may be performed in parallel with the series of processes shown in FIG. 2.

In the first step, i.e., step S161, the device status sensor 120 acquires the status of each safety device. In step S162 subsequent to step S161, whether any safety device (except for the seat belt 31 in the seat 30 in which no occupant has been seated) has been unlocked is determined. When there is no safety device that has been unlocked, the series of processes shown in FIG. 25 ends.

In step S162, when any safety device has been unlocked, the process flow proceeds to step S163. In step S163, whether an autonomous vehicle (i.e., a nearby autonomous vehicle) is traveling around the autonomous vehicle MV is determined. When no nearby autonomous vehicle is traveling nearby, the series of processes shown in FIG. 25 ends. When a nearby autonomous vehicle is traveling nearby, the process flow proceeds to step S164.

In step S164, the process of changing the travel position of the autonomous vehicle MV to a position in front of the nearby autonomous vehicle located in step S163 is performed. Changing the position of the autonomous vehicle MV in this manner corresponds to the safe travel mode in the present embodiment.

In other words, the safe travel mode in the present embodiment is a travel mode in which, when a nearby autonomous vehicle is traveling close to the autonomous vehicle MV, the position of the autonomous vehicle MV is changed to a position in front of the nearby autonomous vehicle. There is a low probability that the nearby autonomous vehicle collides with the rear end of another vehicle traveling in front of the nearby autonomous vehicle. By causing the autonomous vehicle MV to travel at a position in front of such a nearby autonomous vehicle, the probability of rear-end collision of the autonomous vehicle MV with another vehicle can be reduced.

Note that in the case where the aforementioned nearby autonomous vehicle is capable of traveling in a column, the autonomous vehicle MV may be traveling in a column with said nearby autonomous vehicle on the condition that the autonomous vehicle MV is traveling at a position in front of said nearby autonomous vehicle.

The fourth embodiment is described. The present embodiment is the same as the first embodiment except for a portion of the processes performed by the control device 100. Hereinafter, differences from the first embodiment are mainly described, and description of the same features as in the first embodiment is omitted, as appropriate.

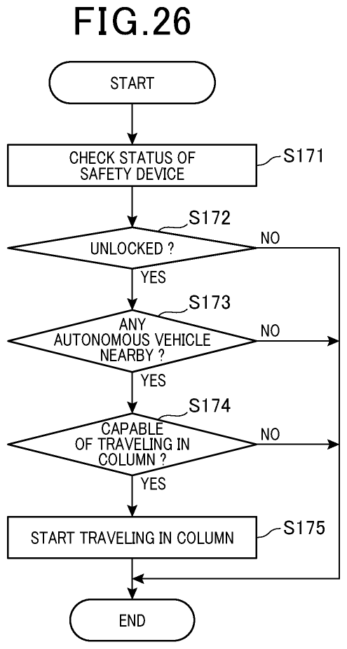

A series of processes shown in FIG. 26 is repeatedly performed by the control device 100, instead of the series of processes shown in FIG. 2, every time a predetermined control period has elapsed. Note that the series of processes shown in FIG. 26 may be performed in parallel with the series of processes shown in FIG. 2.

In the first step, i.e., step S171, the device status sensor 120 acquires the status of each safety device. In step S172 subsequent to step S171, whether any safety device (except for the seat belt 31 in the seat 30 in which no occupant has been seated) has been unlocked is determined. When there is no safety device that has been unlocked, the series of processes shown in FIG. 26 ends.

In step S172, when any safety device has been unlocked, the process flow proceeds to step S173. In step S173, whether one or more autonomous vehicles (i.e., nearby autonomous vehicles) are traveling around the autonomous vehicle MV is determined. When no nearby autonomous vehicles are traveling nearby, the series of processes shown in FIG. 26 ends. When one or more nearby autonomous vehicles are traveling nearby, the process flow proceeds to step S174.

In step S174, whether a vehicle capable of traveling in a column is included in nearby autonomous vehicles located in step S173 is determined. This determination is made based on a response acquired from a nearby autonomous vehicle as a result of the vehicle controller 130 performing the inter-vehicle communication with the nearby autonomous vehicle. When no vehicle capable of traveling in a column is included in the nearby autonomous vehicles, the series of processes shown in FIG. 26 ends. On the other hand, when a vehicle capable of traveling in a column is included, the process flow proceeds to step S175.

In step S175, the process is performed in which the vehicle controller 130 performs the inter-vehicle communication with a nearby autonomous vehicle capable of traveling in a column to cause the autonomous vehicle MV to travel in a column together with the nearby autonomous vehicle (one or more vehicles). Thus, traveling in a column begins. Causing the autonomous vehicle MV to start traveling in a column corresponds to the safe travel mode in the present embodiment.

In other words, the safe travel mode in the present embodiment is a travel mode in which, when a nearby autonomous vehicle is traveling close to the autonomous vehicle MV, the vehicle controller 130 performs the inter-vehicle communication with one or more nearby autonomous vehicles to cause the autonomous vehicle MV to travel in a column together with the one or more nearby autonomous vehicle. By forming a column together with nearby autonomous vehicles, the probability of rear-end collision of the autonomous vehicle MV with another nearby vehicle can be reduced.

Note that the position of the autonomous vehicle MV in the column is preferably a position forward of the tail end of the column and more preferably a position rearward of the leading end of the column.

The present embodiment is thus far described with reference to specific examples. However, the present disclosure is not limited to these specific examples. Modifications resulting from appropriate design changes applied by a person having ordinary skill in the art to these specific examples are also included in the scope of the present disclosure as long as the modifications have the features of the present disclosure. The elements, the arrangement of the elements, the conditions, the shapes, and the like of each of the above-described specific examples are not necessarily limited to those exemplified and can be appropriately changed. A combination of the respective elements included in each of the above-described specific examples can be appropriately changed as long as no technical inconsistency exists.

What is claimed is:

1. A control device of an autonomous vehicle comprising:
a device status sensor which senses a status of a safety device installed to the autonomous vehicle; and
a vehicle controller which controls the autonomous vehicle,
wherein the vehicle controller is capable of implementing each of a normal travel mode and a safe travel mode in which a level of safety is higher than in the normal travel mode, and configured to, in response to the device status sensor sensing that the safety device has been unlocked, perform a process of switching from the normal travel mode to the safe travel mode.

2. The control device according to claim 1, wherein
each of the normal travel mode and the safe travel mode is a travel mode implemented during autonomous driving of the autonomous vehicle.

3. The control device according to claim 2, wherein
the safe travel mode is a travel mode in which an inter-vehicle distance between the autonomous vehicle and a nearby vehicle traveling close to the autonomous vehicle is made greater than the inter-vehicle distance in the normal travel mode.

4. The control device according to claim 3, wherein
the nearby vehicle is a vehicle traveling in front of the autonomous vehicle.

5. The control device according to claim 4, wherein
during implementation of the safe travel mode,
the vehicle controller increases the inter-vehicle distance between the nearby vehicle and the autonomous vehicle by temporarily decelerating the autonomous vehicle.

6. The control device according to claim 5, wherein
in response to another vehicle traveling in a predetermined range behind the autonomous vehicle, the vehicle controller decelerates the autonomous vehicle more slowly than when the other vehicle is not present.

7. The control device according to claim 3, wherein
the nearby vehicle is a vehicle traveling behind the autonomous vehicle.

8. The control device according to claim 7, wherein
during implementation of the safe travel mode, the vehicle controller increases the inter-vehicle distance between the nearby vehicle and the autonomous vehicle by temporarily accelerating the autonomous vehicle.

9. The control device according to claim 3, wherein
during implementation of the safe travel mode, the vehicle controller performs inter-vehicle communication with the nearby vehicle and causes a change in a position of the nearby vehicle to increase the inter-vehicle distance between the nearby vehicle and the autonomous vehicle.

10. The control device according to claim 2, wherein
the safe travel mode is a travel mode in which a travel lane for the autonomous vehicle is changed to a lane different from a travel lane used during implementation of the normal travel mode.

11. The control device according to claim 2, wherein
the safe travel mode is a travel mode in which a travel speed of the autonomous vehicle is set to be less than the travel speed used during implementation of the normal travel mode.

12. The control device according to claim 11, wherein
in response to another vehicle traveling in each of a predetermined range behind the autonomous vehicle and a predetermined range in a lane adjacent to a travel lane for the autonomous vehicle, the vehicle controller performs a process of reducing the travel speed of the autonomous vehicle.

13. The control device according to claim 2, wherein
the safe travel mode is a travel mode in which, in response to a nearby autonomous vehicle different from the autonomous vehicle traveling close to the autonomous vehicle, a position of the autonomous vehicle is changed to a position in front of the nearby autonomous vehicle.

14. The control device according to claim 2, wherein
the safe travel mode is a travel mode in which, in response to one or more nearby autonomous vehicles different from the autonomous vehicle traveling close to the autonomous vehicle, the vehicle controller performs inter-vehicle communication with the one or more nearby autonomous vehicles and causes the autonomous vehicle to travel in a column together with the one or more nearby autonomous vehicles.

15. The control device according to claim 2, wherein
in response to one or more nearby autonomous vehicles different from the autonomous vehicle traveling close to the autonomous vehicle, the vehicle controller performs inter-vehicle communication with the one or more nearby autonomous vehicles and causes the autonomous vehicle to travel in a column together with the one or more nearby autonomous vehicle, and
the safe travel mode is a travel mode in which the autonomous vehicle that is traveling in the column is positioned to travel at a position in a second last place in the column or at a position forward of the second last place in the column.

16. The control device according to claim 15, wherein
the vehicle controller causes the autonomous vehicle to travel at a position in a second front place in the column or at a position rearward of the second front place in the column.

17. The control device according to claim 15, wherein
the vehicle controller performs the inter-vehicle communication with the one or more nearby autonomous vehicles and causes a change in a position of the autonomous vehicle in the column without changing a travel lane for the autonomous vehicle.

18. The control device according to claim 1, wherein
the safe travel mode is a travel mode in which, in response to a nearby autonomous vehicle different from the autonomous vehicle traveling close to the autonomous vehicle, the vehicle controller performs a process of requesting the nearby autonomous vehicle to pass at a low relative speed through a predetermined range set around the autonomous vehicle.

19. The control device according to claim 1, wherein
the safe travel mode is a travel mode in which, in response to a nearby autonomous vehicle different from the autonomous vehicle traveling close to the autonomous vehicle, the vehicle controller performs a process of requesting the nearby autonomous vehicle not to enter a predetermined range set around the autonomous vehicle.

20. The control device according to claim 1, wherein
the safe travel mode is a travel mode in which, in response to a nearby autonomous vehicle different from the autonomous vehicle traveling close to the autonomous vehicle, the vehicle controller performs one of the following:
a first request process of requesting the nearby autonomous vehicle to pass at a low relative speed through a predetermined range set around the autonomous vehicle; and
a second request process of requesting the nearby autonomous vehicle not to enter the predetermined range.

21. The control device according to claim 20, wherein
the vehicle controller switches between performing the first request process and performing the second request process according to a travel speed of the autonomous vehicle.

22. The control device according to claim 21, wherein
when the travel speed of the autonomous vehicle is greater than a predetermined speed, the vehicle controller performs the first request process, and when the travel speed of the autonomous vehicle is less than the predetermined speed, the vehicle controller performs the second request process.

23. The control device according to claim 20, wherein
the safety device comprises a seat belt installed to a seat of the autonomous vehicle, and a locking mechanism which locks a door of the autonomous vehicle, and
in response to the device status sensor sensing that both of the seat belt and the locking mechanism have been unlocked, the vehicle controller performs the second request process.

24. The control device according to claim 18, wherein
the vehicle controller sets the predetermined range according to a position of the safety device that has been unlocked.

25. The control device according to claim 1, wherein
in response to the device status sensor sensing that the safety device has been unlocked during travel of the autonomous vehicle through manual driving by a driver, the vehicle controller performs a process of implementing the safe travel mode after switching from the manual driving to autonomous driving.

26. The control device according to claim 25, wherein
the safety device is installed to a driver seat of the autonomous vehicle.

27. The control device according to claim 1, further comprising:
an operating unit which is operated by an occupant to start autonomous driving, wherein
when the operating unit is operated and the device status sensor senses that the safety device has been unlocked, the vehicle controller does not perform a process of starting the autonomous driving.
